(19) United States
(12) Patent Application Publication
(10) Pub. No.: US 2017/0096070 A1
(43) Pub. Date: Apr. 6, 2017

(54) METHOD FOR CONTROLLING BRAKING OF REGENERATIVE BRAKING CO-OPERATIVE CONTROL SYSTEM FOR VEHICLE

(71) Applicant: Hyundai Motor Company, Seoul (KR)

(72) Inventors: Dong Yoon HYUN, Seoul (KR); Jong Yun JEONG, Hwaseong-si (KR)

(73) Assignee: Hyundai Motor Company, Seoul (KR)

(21) Appl. No.: 15/232,663

(22) Filed: Aug. 9, 2016

(30) Foreign Application Priority Data
Oct. 6, 2015 (KR) 10-2015-0140361

(51) Int. Cl. B60L 7/26

(52) U.S. Cl. CPC B60L 7/26; B60L 2240/461; B60L 2240/465

(57) ABSTRACT

A method for controlling braking of a regenerative braking co-operative control system for a vehicle may include detecting, by a controller, whether a brake pedal is manipulated, determining, by the controller, a driver demand braking force, a wheel deceleration, and wheel slip when the brake pedal is manipulated, comparing, by the controller, the determined wheel deceleration value and the wheel slip value with a predetermined threshold deceleration value and a predetermined first threshold slip value, respectively, and determining, by the controller, a maximum road frictional force when the wheel deceleration value is larger than the threshold deceleration value and the wheel slip value is larger than the first threshold slip value and determining a regenerative braking force of driving wheels in accordance with the determined maximum road frictional force.

### CROSS-REFERENCE TO RELATED APPLICATION

The present application claims priority to Korean Patent Application No. 10-2015-0140361, filed Oct. 6, 2015, the entire contents of which is incorporated herein for all purposes by this reference.

### BACKGROUND OF THE INVENTION

Field of the Invention

The present invention relates to a method for controlling braking of a regenerative braking co-operative control system for a vehicle. More particularly, the present invention relates to a method for controlling braking of a vehicle by distributing a braking force in a regenerative braking co-operative control system of an eco-friendly vehicle which is driven by a motor, such as a hybrid vehicle or an electric vehicle.

Description of Related Art

As well known, when a vehicle which is driven using an electric motor, that is, an eco-friendly vehicle such as an pure electric vehicle (EV), a hybrid vehicle (HEV), or a fuel cell electric vehicle (FCEV) applies a brake, regenerative braking is performed.

A regenerative braking system of the eco-friendly vehicle converts kinetic energy of the vehicle into electric energy to store the electric energy in a battery while braking the vehicle and then the energy is reused (a collected electric energy is reused as a kinetic energy of the vehicle) to drive an electric motor when the vehicle is driven, thereby improving fuel efficiency of the vehicle.

In the vehicle in which the regenerative braking is performed, a regenerative braking co-operative control technique which allows a sum of a regenerative braking torque generated in the electric motor (a driving motor) and a frictional braking torque generated in a frictional brake device (a hydraulic brake device) to satisfy a driver demand braking torque during the regenerative braking is required.

In this case, it is necessary to appropriately distribute an electric braking force caused by an electricity generating operation and a rotational resistance of the motor, that is, a regenerative braking force and a frictional braking force by a frictional brake device.

In a case of a vehicle in which a driving motor is mounted in front wheels, the regenerative braking is performed only in the front wheels which are driving wheels, so that the regenerative braking co-operative control technique which concentrates the braking force on the front wheels is applied in order to increase energy recovery efficiency.

FIG. 1 is a view illustrating a braking force distributing method of the related art and shows an example in which the regenerative braking force and the frictional braking force are distributed in accordance with a driver demand braking deceleration D.

As illustrated in FIG. 1, when a demand braking force is smaller than a maximum regenerative braking force, only the front wheel regenerative braking force is used to apply the brake without using the frictional braking force of the front and rear wheels. However, when the demand braking force is larger than the maximum regenerative braking force, the maximum regenerative braking force is used and a braking force corresponding to a difference between the demand braking force and the maximum braking force is applied as the frictional braking force. The frictional braking force is distributed by various methods and a frictional braking force of the front wheels and a frictional braking force of the rear wheels are appropriately distributed as much as a braking force is required in accordance with a set control logic, and used.

However, since a road friction characteristic is not considered in the regenerative braking system of the related art, when a braking force A which is larger than a maximum road frictional force of the front wheels is required, front wheel lock is generated. That is, when the demand braking force of the vehicle is larger than the maximum road frictional force of the front wheels, as illustrated in FIG. 1, the regenerative braking force of the front wheels is larger than the maximum road frictional force, which causes the front wheel lock.

Therefore, an anti-lock brake system (ABS) frequently operates, which causes safety concerns to a driver. Further, when the front wheel lock is generated, a motor stops and thus the regenerative braking stops. Therefore, the braking is performed only using the frictional braking so that the energy recovery efficiency is reduced and thus fuel efficiency is not maximized.

Therefore, a control strategy which appropriately distributes the regenerative braking force and the frictional braking force in accordance with road friction to maximize the regenerative braking is needed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for controlling braking of a regenerative braking co-operative control system for a vehicle which controls distribution of a regenerative braking force and a frictional braking force in consideration of a road condition to suppress frequent operation of the ABS by locking of driving wheels.

Additionally, various aspects of the present invention are directed to providing a method for controlling braking of a regenerative braking co-operative control system for a vehicle which maximizes regenerative braking while securing braking stability, to improve fuel efficiency together with driving stability.

According to various aspects of the present invention, a method for controlling braking of a regenerative braking co-operative control system for a vehicle may include detecting, by a controller, whether a brake pedal is manipulated, determining, by the controller, a driver demand braking force, a wheel deceleration, and wheel slip when the brake pedal is manipulated, comparing, by the controller, the determined wheel deceleration value and the wheel slip value with a predetermined threshold deceleration value and a predetermined first threshold slip value, respectively, and determining, by the controller, a maximum road frictional force when the wheel deceleration value is larger than the threshold deceleration value and the wheel slip value is larger than the first threshold slip value and determining a regenerative braking force of driving wheels in accordance with the determined maximum road frictional force.

When the wheel deceleration value is equal to or smaller than the threshold deceleration value or the wheel slip value is equal to or smaller than the first threshold slip value, a braking force may be distributed in accordance with a predetermined braking force distributing map, without considering the maximum road frictional force.

The method may further include comparing, by the controller, the demand braking force and the maximum regenerative braking force when the wheel deceleration value is larger than the threshold deceleration value and the wheel slip value is larger than the first threshold slip value, in which when the demand braking force is smaller than the maximum regenerative braking force, the determining the regenerative braking force of the driving wheels in accordance with the maximum road frictional force is reached.

When the demand braking force is equal to or larger than the maximum regenerative braking force, an anti-lock brake system (ABS) may operate.

In the detecting whether the brake pedal is manipulated, a brake pedal stroke or a brake pedal effort may be detected to determine whether the brake pedal is manipulated, and the method may further include determining a pedal stepping speed from the brake pedal stroke or the brake pedal effort.

The method may further include comparing, by the controller, the determined pedal stepping speed with a predetermined threshold pedal speed, in which when the pedal stepping speed is equal to or larger than the predetermined threshold pedal speed, the ABC may operate and when the pedal stepping speed is smaller than the predetermined threshold pedal speed, the determining the regenerative braking force of the driving wheels in accordance with the maximum road frictional force may be reached.

Even when the pedal stepping speed is smaller than the predetermined threshold pedal speed, the ABS may operate without entering the determining of a regenerative braking force of driving wheels in accordance with the maximum road frictional force when the determined wheel slip is larger than a predetermined second threshold slip value.

In the determining of the regenerative braking force of the driving wheels in accordance with the maximum road frictional force, the road frictional coefficient may be determined and the maximum road frictional force of the driving wheels may be determined from the determined road frictional coefficient, and when the demand braking force is larger than the maximum road frictional force, a braking force corresponding to the determined maximum road frictional force may be distributed as a regenerative braking force of the driving wheels and a value obtained by subtracting the maximum road frictional force from the demand braking force may be distributed as a frictional braking force of passive driving wheels.

The road frictional coefficient may be defined by a value obtained by dividing a vehicle deceleration value, when a deceleration of the driving wheels is equal to or larger than a predetermined threshold value, by a gravitational acceleration.

In the method for controlling braking of a regenerative braking co-operative control system for a vehicle according to the present invention, whether to perform regenerative braking is determined and the braking forces of the driving wheels and passive driving wheels are distributed in consideration of road conditions, so that it is possible to effectively prevent a braking distance from being increased due to wheel lock of the driving wheel and regenerative braking from stopping, and improve fuel efficiency of the vehicle.

In the present invention, it is determined to distribute the braking force or whether to operate the ABS in consideration of conditions such as wheel deceleration or wheel slip, so that braking stability is secured. Further, a regenerative braking area for various road conditions may be maximized within a range where the braking stability is secured, so that a method for controlling braking of a regenerative braking co-operative control system for a vehicle which improves not only the driving stability but also the fuel efficiency is provided.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a braking force distributing method of the related art.

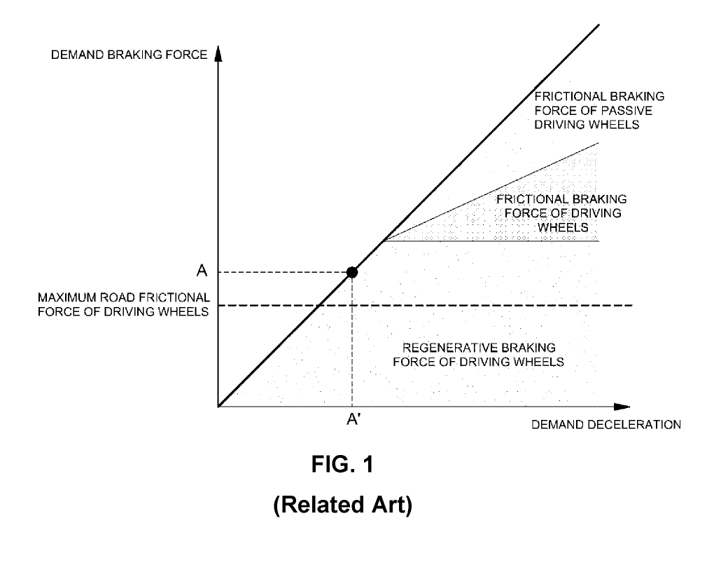

FIG. 2 is a flowchart illustrating an exemplary braking control method according to the present invention.

FIG. 3 schematically illustrates a braking force distributing state in a normal driving state according to the present invention.

FIG. 4 is a view schematically illustrating a braking force distributing state when front wheels are locked according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a method for controlling braking of a regenerative braking co-operative control system for a vehicle included in a two-wheel driving vehicle of a front wheel driving method or a rear wheel driving method and provides a method for controlling braking of a regenerative braking co-operative control system for a vehicle which determines whether to perform regenerative braking and a regenerative braking force of the driving wheels in consideration of a road condition, and more clearly, in consideration of a road frictional coefficient and maximizes the regenerative braking in a range where a frequent operation of the ABS is suppressed.

Specifically, in various embodiments of the present invention, various conditions for wheel deceleration or wheel slip are set and distribution of the braking force is controlled depending on whether various conditions are satisfied. Further, in the present invention, whether to operate the ABS is determined through steps so that the regenerative braking is efficiently performed within a range where an unnecessary ABS operation is suppressed.

Specifically, in the method for controlling braking of a regenerative braking co-operative control system for a vehicle according to the present invention, a maximum road frictional force is calculated to efficiently distribute the braking force within a range where the regenerative braking is maximized in consideration of the road condition and the regenerative braking force of the driving wheels and a frictional braking force of passive driving wheels are distributed from the calculated maximum road frictional force.

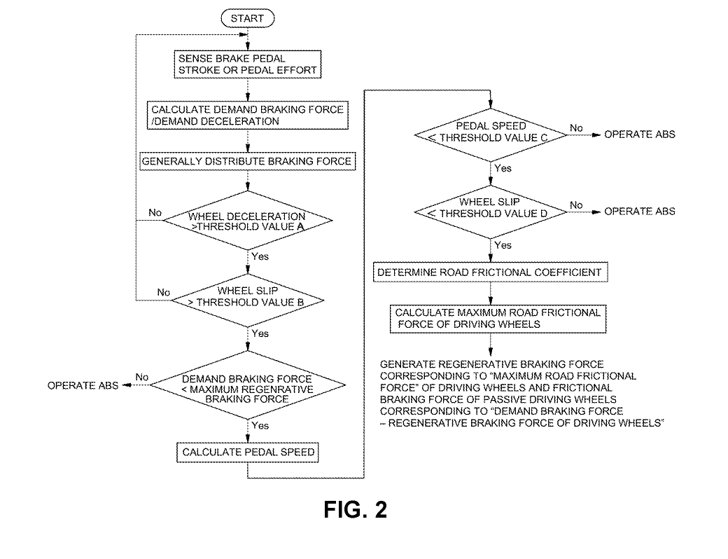

FIG. 2 is a flowchart illustrating a method for controlling braking of a regenerative braking co-operative control system for a vehicle according to various embodiments of the present invention. In various embodiments of the present invention, steps of the method for controlling braking of a regenerative braking co-operative control system for a vehicle may be performed by a controller, e.g., a Transmission Control Unit (TCU).

As illustrated in FIG. 2, in the method for controlling braking of a regenerative braking co-operative control system for a vehicle according to the present invention, whether a driver manipulates a brake pedal is determined and when it is determined that the driver manipulates the brake pedal, a series of steps for distributing the braking force between front wheels and rear wheels are performed.

Here, a brake pedal stroke or brake pedal effort is detected to determine whether the driver manipulates the brake pedal.

When the driver puts the brake pedal and the pedal stroke or the brake pedal effort is detected, a step of calculating parameters which determine braking force distribution, such as a driver demand braking force, is performed.

When the driver puts the brake pedal, a pedal stroke amount is detected through a pedal stroke sensor or a pedal effort sensor and a driver demand braking force is calculated through information such as a current vehicle speed which is detected from a vehicle speed sensor. Various calculating methods and various calculating processes of the driver demand braking force are known and the demand deceleration is a value obtained by dividing the demand braking force by a mass of the vehicle. Therefore, in the present invention, the method of calculating the demand braking force and the demand deceleration and the process thereof are not specifically limited (a known method is selectively applied) and description of the calculating method and the process thereof will be omitted in the present specification.

In the meantime, the wheel deceleration and the wheel slip of a vehicle which is being driven are also calculated in addition to the demand braking force. For example, the wheel deceleration is calculated by measuring wheel speeds of four wheels and the wheel slip is defined by a value obtained by dividing a value, which is obtained by subtracting the wheel speed from a wheel center speed, by the wheel speed, that is, (wheel center speed−wheel speed)/wheel speed.

When it is determined that it is not necessary to consider the road frictional coefficient and the maximum road frictional force when the braking force is distributed, the wheel deceleration and the wheel slip values are used to generally distribute braking force, instead of distributing the braking force in consideration of the maximum road frictional force.

Specifically, the process is performed through a process of comparing the calculated wheel deceleration and the wheel slip values with a predetermined threshold value.

Threshold values for the wheel deceleration and the wheel slip may be set to upper limit values at which the wheel lock may not be generated within a range of the current demand braking force and demand deceleration.

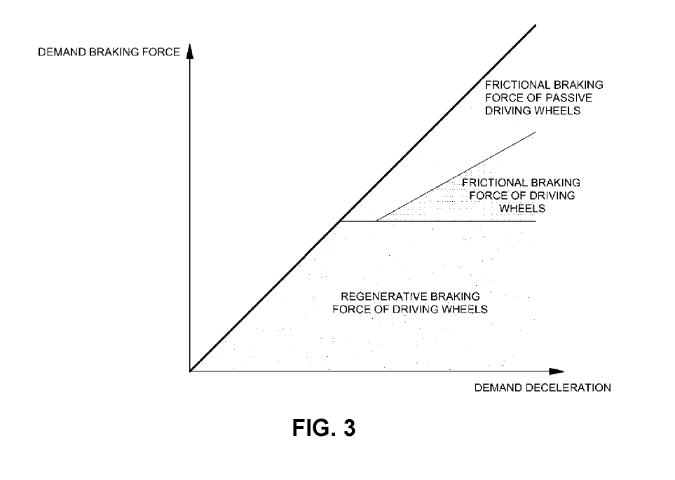

That is, as illustrated in FIG. 2, in a step of comparing the wheel deceleration and a threshold value A, when the wheel deceleration is equal to or smaller than a predetermined threshold deceleration value A, it is determined that it is not necessary to distribute the braking force in consideration of the maximum road frictional force and regenerative braking co-operative control is performed in accordance with a general braking force distributing method as illustrated in FIG. 3.

The threshold deceleration A indicates a wheel deceleration and means a time differential value of the wheel speed. Therefore, the threshold deceleration A is defined as a wheel deceleration value calculated when the wheel lock is generated and it means that when the wheel deceleration is smaller than the threshold value A, there are no concerns over the wheel lock. For example, when the wheel lock is generated, if the wheel deceleration is equal to or larger than 1.5 g, the threshold deceleration A is determined to be 1.5 g.

Therefore, in a general braking force distributing method, as illustrated in FIG. 3, when the demand braking force is smaller than the maximum regenerative braking force, the vehicle applies a brake only using a regenerative braking force of the driving wheels corresponding to the demand braking force and when the demand braking force is larger than the maximum regenerative braking force, the vehicle applies a brake appropriately using the frictional braking force of the driving wheels and the frictional braking force of the passive driving wheel for a braking force corresponding to a difference between the demand braking force and the maximum regenerative braking force.

The general distribution of the braking force is determined from the demand braking force and the demand deceleration in accordance with a braking force distributing map stored in the controller in the vehicle.

Next, in various embodiments, when the wheel deceleration is larger than a predetermined threshold deceleration value A, a step of comparing the calculated wheel slip value with a predetermined first threshold slip value B is performed. However, the step of comparing the wheel slip value may be performed before, after or simultaneously with the step of comparing a wheel deceleration but is not limited to the determining order of FIG. 2.

In this step, when the wheel slip value is equal to or smaller than the predetermined first threshold slip value B, the regenerative braking co-operative control is performed in accordance with a general braking force distributing method as illustrated in FIG. 3.

With regard to this, as defined above, the wheel slip value is defined by a value obtained by dividing a value, which is obtained by subtracting the wheel speed from a wheel center speed, by the wheel speed, that is, (wheel center speed−wheel speed)/wheel speed and generally, when the slip value is equal to or larger than approximately 0.3, a state of the vehicle is unstable on any of roads and wheel lock is generated.

Therefore, in the various embodiments of the present invention, the first threshold slip value B is selected to be approximately 0.3 and when the wheel slip value of the vehicle is equal to or larger than the first threshold slip value, it is determined as a dangerous situation (wheel lock).

Therefore, in various embodiments of the present invention, only when the wheel deceleration is larger than the threshold deceleration value A and the wheel slip value is larger than the first threshold slip value B, is the braking force distribution control performed in consideration of the road frictional coefficient.

In the meantime, in various embodiments, a step of calculating a pedal stepping speed of when the driver steps on the brake pedal and comparing the pedal stepping speed (pedal speed) with a predetermined threshold pedal speed C is further provided.

Here, the pedal stepping speed corresponds to a time differential value of the brake pedal stroke and is determined from the brake pedal stroke or the brake pedal effort value which is detected from the pedal stroke sensor or the pedal effort sensor as described above.

In this step, when the pedal stepping speed is equal to or larger than the predetermined threshold pedal speed C, the ABS operates. In contrast, when the pedal stepping speed is smaller than the predetermined threshold pedal speed C, a step of determining the regenerative braking force of the driving wheels in accordance with the maximum road frictional force is reached.

The pedal stepping speed is detected in order to determine whether to perform emergency braking through the pedal stepping speed of the driver and when the pedal stepping speed is larger than the threshold value C, it is determined to perform emergency braking to operate the ABS.

Therefore, in various embodiments, only when a condition, in which the calculated wheel deceleration and the calculated wheel slip value are larger than the threshold deceleration value A and the first threshold slip value B respectively is satisfied, and the demand braking force is smaller than the maximum regenerative braking force which is transmitted to the driving wheels and the detected pedal speed is smaller than a predetermined threshold pedal speed C, the road frictional coefficient is determined and the braking force is distributed in accordance with the road frictional coefficient.

Here, the road frictional coefficient is defined by a value obtained by dividing a vehicle deceleration value of when two conditions (wheel deceleration>threshold deceleration A) and (wheel slip value>first threshold slip value B) are satisfied by a gravitational acceleration and may use a value which is indirectly obtained from the wheel speed or directly measured.

In the meantime, as illustrated in FIG. 2, when the pedal stepping speed is equal to or larger than the predetermined threshold pedal speed C, the ABC operates without entering a step of determining the regenerative braking force of the driving wheels in accordance with the maximum road frictional force.

In the meantime, in consideration of a case when the wheel slip is excessively large, for braking safety, the step of comparing the wheel slip value with the second threshold slip value D may be added before the step of distributing the braking force in consideration of the maximum road frictional force.

That is, as illustrated in FIG. 2, when the calculated wheel slip value is equal to or larger than the predetermined second threshold slip value D, the ABS operates in consideration of the braking safety. In contrast, when the wheel slip value is smaller than the second threshold slip value D, the road frictional coefficient is determined and the determined road frictional coefficient and a load of the vehicle driving wheels are multiplied to calculate a maximum road frictional force which is generated by the driving wheels, and then the braking force is distributed in accordance with the calculated maximum road frictional force.

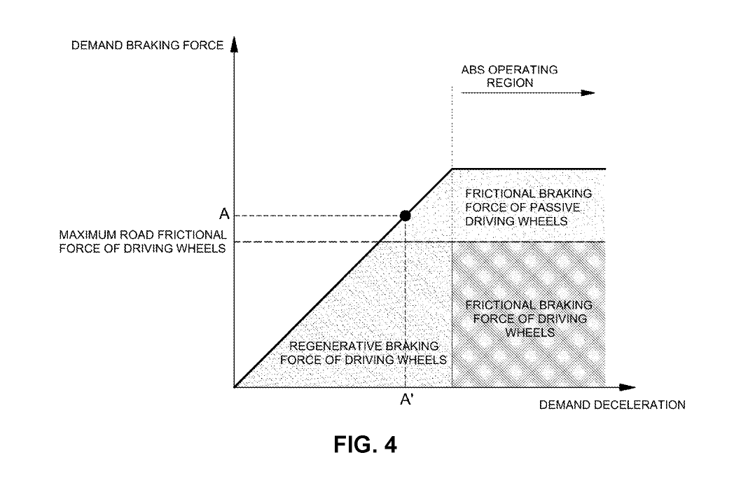

An example of distributing the braking force in consideration of the maximum road frictional force is illustrated in FIG. 4. That is, as illustrated in FIG. 4, the braking force corresponding to the maximum road frictional force determined as described above means the maximum regenerative braking force by which the driving wheels possibly perform the regenerative braking. Therefore, the braking force corresponding to the maximum road frictional force is distributed as the regenerative braking force of driving wheels and a difference between the demand braking force and the regenerative braking force (maximum road frictional force) of the driving wheels is distributed as the frictional braking force of the passive driving wheels.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling braking of a regenerative braking co-operative control system for a vehicle, the method comprising:
detecting, by a controller, whether a brake pedal is manipulated;
determining, by the controller, a driver demand braking force, a wheel deceleration, and wheel slip when the brake pedal is manipulated;
comparing, by the controller, the determined wheel deceleration value and the wheel slip value with a predetermined threshold deceleration value and a predetermined first threshold slip value, respectively; and
determining, by the controller, a maximum road frictional force when the wheel deceleration value is larger than the threshold deceleration value and the wheel slip value is larger than the first threshold slip value and determining a regenerative braking force of driving wheels in accordance with the determined maximum road frictional force.

2. The method of claim 1, wherein when the wheel deceleration value is equal to or smaller than the threshold deceleration value or the wheel slip value is equal to or smaller than the first threshold slip value, a braking force is distributed in accordance with a predetermined braking force distributing map, without considering the maximum road frictional force.

3. The method of claim 1, further comprising:
comparing, by the controller, the demand braking force and the maximum regenerative braking force when the wheel deceleration value is larger than the threshold deceleration value and the wheel slip value is larger than the first threshold slip value,
wherein when the demand braking force is smaller than the maximum regenerative braking force, the determining the regenerative braking force of the driving wheels in accordance with the maximum road frictional force is reached.

4. The method of claim 3, wherein when the demand braking force is equal to or larger than the maximum regenerative braking force, an anti-lock brake system (ABS) operates.

5. The method of claim 3, wherein in the detecting whether the brake pedal is manipulated, a brake pedal stroke or a brake pedal effort is detected to determine whether the brake pedal is manipulated, and the method further comprises determining a pedal stepping speed from the brake pedal stroke or the brake pedal effort.

6. The method of claim 5, further comprising comparing, by the controller, the determined pedal stepping speed with a predetermined threshold pedal speed, wherein when the pedal stepping speed is equal to or larger than the predetermined threshold pedal speed, the ABC operates and when the pedal stepping speed is smaller than the predetermined threshold pedal speed, the determining the regenerative braking force of the driving wheels in accordance with the maximum road frictional force is reached.

7. The method of claim 6, wherein even when the pedal stepping speed is smaller than the predetermined threshold pedal speed, the ABS operates without entering the determining of a regenerative braking force of driving wheels in accordance with the maximum road frictional force when the determined wheel slip is larger than a predetermined second threshold slip value.

8. The method of claim 1, wherein in the determining of the regenerative braking force of the driving wheels in accordance with the maximum road frictional force, the road frictional coefficient is determined and the maximum road frictional force of the driving wheels is determined from the determined road frictional coefficient, and
when the demand braking force is larger than the maximum road frictional force, a braking force corresponding to the determined maximum road frictional force is distributed as a regenerative braking force of the driving wheels and a value obtained by subtracting the maximum road frictional force from the demand braking force is distributed as a frictional braking force of passive driving wheels.

9. The method of claim 8, wherein the road frictional coefficient is defined by a value obtained by dividing a vehicle deceleration value, when a deceleration of the driving wheels is equal to or larger than a predetermined threshold value, by a gravitational acceleration.
